(19) United States
(12) Patent Application Publication
(10) Pub. No.: US 2008/0042865 A1
(43) Pub. Date: Feb. 21, 2008

(54) Loading dock monitoring device and method

(75) Inventors: Jimmy Lee Shephard, Bartlett, TN (US); Joe Wilson Wortsmith, White Hall, AR (US); Roger Frederick Johnson, Bellevue, WA (US); James LeVaughn Varnedoe, Oakland, TN (US)

Correspondence Address: Russell H. Walker;Walker, McKenzie & Walker, P.C., Suite 434, 6363 Poplar Avenue, Memphis, TN, 38119-4896, US

(73) Assignee: Dock Watch, LLC, Bartlett, TN (US)

(21) Appl. No.: 11/501,677

(22) Filed: Aug. 9, 2006

(51) Int. Cl. G08B 21/00; G08G 1/14

(52) U.S. Cl. 340/686.6; 340/932.2

(57) ABSTRACT

A dock monitoring device that provides a warning to dock workers and a lift truck operator that a hazardous condition exists if the distance from a parked load transport vehicle to the rear of a loading dock increases outside a preset “safe zone” distance, which is the maximum distance, with allowance for a safety margin, that can be spanned by a dock plate or ramp or “dock leveler” to the bed floor of the load transport vehicle. The invention uses a non-contact distance measuring sensor such as an infrared optical triangulation measuring sensor. An alarm will sound if the distance becomes greater than a preset “safe zone” distance. Significant events are logged, and a picture of the load may be taken.

### STATEMENT REGARDING FEDERALLY SPONSORED RESEARCH OR DEVELOPMENT

Not applicable.

### REFERENCE TO COMPACT DISC(S)

Not applicable.

### BACKGROUND OF THE INVENTION

1. Field of the Invention

The present invention relates, in general, to equipment used at vehicle loading docks, and, in general, to devices for monitoring vehicles parked at a loading dock.

2. Information Disclosure Statement

Loading docks for load transport vehicles such as, for example, tractor trailers, are well known, and have a raised dock at a height above the surface on which the wheels of the load transport vehicle rest, and the height of the dock above that surface is designed to be approximately the height of the inside bed floor of the load transport vehicle. Well-known dock bumpers are provided on the exposed wall face of the dock toward the vehicle loading space to cushion against a vehicle bumping into the dock during docking. When a load transport vehicle backs up to a loading dock and then parks, a well-known ramp or “dock plate” or so-called dock leveler is used to span the gap between the parked load transport vehicle and the dock so that fork lift trucks and/or loading dock workers can move back and forth from the dock to the load transport vehicle during loading and unloading of the load transport vehicle.

A problem with such loading dock procedures of using a ramp or dock plate or dock leveler to span the gap between the dock and the load transport vehicle's bed floor is that, while a vehicle is parked during loading, it occasionally shifts position (“creeps forward”) and/or “rocks” forward and backward as the lift truck enters and leaves the vehicle during loading, causing impact and vibrations, or because of poorly-set wheel chocks, or because of adverse surface conditions of dirt, sand, gravel, snow, ice and oil or grease mixed with water on the surface on which the load transport vehicle is parked. Occasionally, unmonitored and/or uncoordinated with ongoing dock operations, a driver may inadvertently cause a “premature departure” event by driving the load transport vehicle away from the dock while it is still being unloaded or loaded, or other vehicles may inadvertently hit the parked load transport vehicle, causing it to move from its parked position. Regardless of the cause of the “trailer creep” or “trailer separation” of the load transport vehicle from the dock, the gap distance from the dock to the vehicle often increases, occasionally to the point that the ramp or dock plate or dock leveler falls into the gap between the dock and the load transport vehicle because of the increase in distance between the dock and the load transport vehicle. Such a catastrophic event caused by this “trailer creep” or “trailer separation” from the dock creates a significant safety hazard for dock workers as they load and unload the load transport vehicle. This catastrophic event can even occur with prior art restraint systems such as a so-called “ICC bar” that utilizes a hooked clamp from the dock onto a rear underside rail of a load transport vehicle, especially if the restraint system is damaged or not properly maintained.

It is therefore desirable to monitor a parked load transport vehicle at a dock for “creep” and movement that might create an unsafe condition.

Furthermore, it is desirable to log events such as arrival, departure, premature departure, loading/unloading completion, etc., to notify the driver when the driver's presence is needed at the dock, and to record a picture of the loaded vehicle prior to departure.

A preliminary patentability search in Class 340, Subclasses 463, 686.6, 431, 435 and 939; Class 14, Subclasses 71.3 and 69.5; and text searching on the Patent and Trademark Office EAST database system produced the following patents and patent publications, some of which may be relevant to the present invention: Ehrlich et al., U.S. Appl. Publication 2001/0052434 (published Dec. 20, 2001); Pietsch et al., U.S. Appl. Publication 2002/0017412 (published Feb. 14, 2002); Goggin, U.S. Appl. Publication 2005/0122218 (published Jun. 9, 2005); Muhl et al., U.S. Appl. Publication 2005/0150065 (published Jul. 14, 2005); Keklak et al., U.S. Pat. No. 4,680,571 (issued Jul. 14, 1987); Kirtley et al., U.S. Pat. No. 4,849,735 (issued Jul. 18, 1989); Larson et al., U.S. Pat. No. 5,257,431 (issued Nov. 2, 1993); Springer et al., U.S. Pat. No. 5,440,772 (issued Aug. 15, 1995); Gelder et al., U.S. Pat. No. 5,457,838 (issued Oct. 17, 1995); Streeter et al., U.S. Pat. No. 5,950,266 (issued Sep. 14, 1999); Payne et al, U.S. Pat. No. 6,693,524 (issued Feb. 17, 2004); and Li, U.S. Pat. No. 6,865,138 (issued Mar. 8, 2005).

Those prior art references that are directed to monitoring a parked vehicle generally teach mechanical, rather than non-contact, distance monitoring devices such as cables or linkages or mechanical limit switches that sense the position of the parked vehicle, and often require manual connection of a linkage or cable from the dock to the vehicle. Other prior art devices aid in the process of parking a vehicle or are for vehicle collision avoidance, but do not monitor the position of a parked vehicle.

Additionally, Henderson, U.S. Design Pat. No. Des. 371,054 (issued Jun. 25, 1996) and Lovegreen et al., U.S. Pat. No. 5,814,968 (issued Sep. 29, 1998), describe an annunciator paging device that may be used with one of the preferred embodiments of the present invention. This annunciator paging device is also described in the brochure entitled OEM Transmitter Operating Manual—Installation & Warranty Information published by Long Range Systems, Inc. (October 2004, revised July 2005).

Programmable microchip controllers such as the PIC16F636 are well known. The PIC16F636 family is described in the PIC16F630/676Data Sheet published by Microchip Technology, Inc. (2003).

Optical distance measuring sensors such as the GP2Y0A02YK are well known and are described in the publication entitled GP2Y0A02YK Long Distance Measuring Sensor published by Sharp Corporation (date unknown) and in the application note entitled General Application Note: Distance Measuring Sensors, also published by Sharp Corporation (Feb. 18, 2003).

None of these references, either singly or in combination, disclose or suggest the present invention.

### BRIEF SUMMARY OF THE INVENTION

The present invention is a monitoring device that provides a warning to dock workers and the lift truck operator that a hazardous condition exists if the distance from a parked load transport vehicle to the rear of a loading dock increases outside a preset “safe zone” distance, which is the maximum distance, with allowance for several inches of safety margin, that can be spanned by a dock plate or ramp or “dock leveler” to the bed floor of the load transport vehicle.

The monitoring device is mounted adjacent to or on the loading dock, preferably placed between the loading dock bumpers, facing outward toward the parked load transport vehicle, and a non-contact distance measuring sensor, in combination with electronics in the device, monitors the gap distance from the loading dock to the parked load transport vehicle. In contrast to prior art devices that use mechanical means such as cables, ropes. linkages, and/or limit switches to monitor the distance to the load transport vehicle, the present invention uses a non-contact distance measuring sensor. An alarm will sound if the distance becomes greater than a preset “safe zone” distance.

Because the device senses the presence of the load transport vehicle as it measures the distance to the rear of the vehicle, it may also note and log the time of arrival and departure at the dock, and may take a picture of the load transport vehicle while it is docked. An annunciator/pager is preferably provided to alert the driver that the driver's attention is needed at the dock, and an interface is preferably provided to a shipping database.

It is an object of the present invention to measure a gap distance between a loading dock and a parked load transport vehicle, and to provide an alarm when the measured gap distance is outside a selected limit distance.

It is a further object of the present invention to provide operator input means for inputting data relating to the load transport vehicle's cargo, to provide logging means to log events and data, to provide a camera for photographing the load transport vehicle while it is parked at the dock, and to provide an interface to a database.

It is a still further object of the invention to provide notification means for notifying the load transport vehicle's driver that the driver's attention is needed at the loading dock.

### BRIEF DESCRIPTION OF THE SEVERAL VIEWS OF THE DRAWING

FIG. 1 is a partial side perspective view of the device of the present invention mounted between dock bumpers and monitoring a parked load transport vehicle.

FIG. 2 is a side view of the device of the present invention monitoring a parked load transport vehicle, showing movement of the vehicle away from the dock.

FIG. 3 is a schematic block diagram of the device of the present invention showing various inputs and outputs.

FIG. 4 is a prior art diagram showing the operation of a prior art optical distance measuring sensor such as the Sharp GP2Y0A02YK that is used with a preferred embodiment of the present invention.

FIG. 5 is a schematic of the basic dock monitoring device of the present invention.

FIG. 6 is a basic flow diagram showing signal flow to and from the portions of the present invention.

FIGS. 7A and 7B, when joined together with FIG. 7A immediately above FIG. 7B, are a flowchart showing the programmatic operation of a microcomputer that controls the operation of the present invention.

FIG. 8 is a flow diagram showing high-level functions of the present invention.

FIG. 9 is a graph of the output voltage of the Sharp GP2Y0A02YK distance measuring sensor as a function of distance to the reflective object.

FIG. 10 is a table showing exemplary values for “near” and “far” window threshold selections (as measured from the front of the enclosure to the target) as a selectable function of a switch of the present invention.

### DETAILED DESCRIPTION OF THE INVENTION

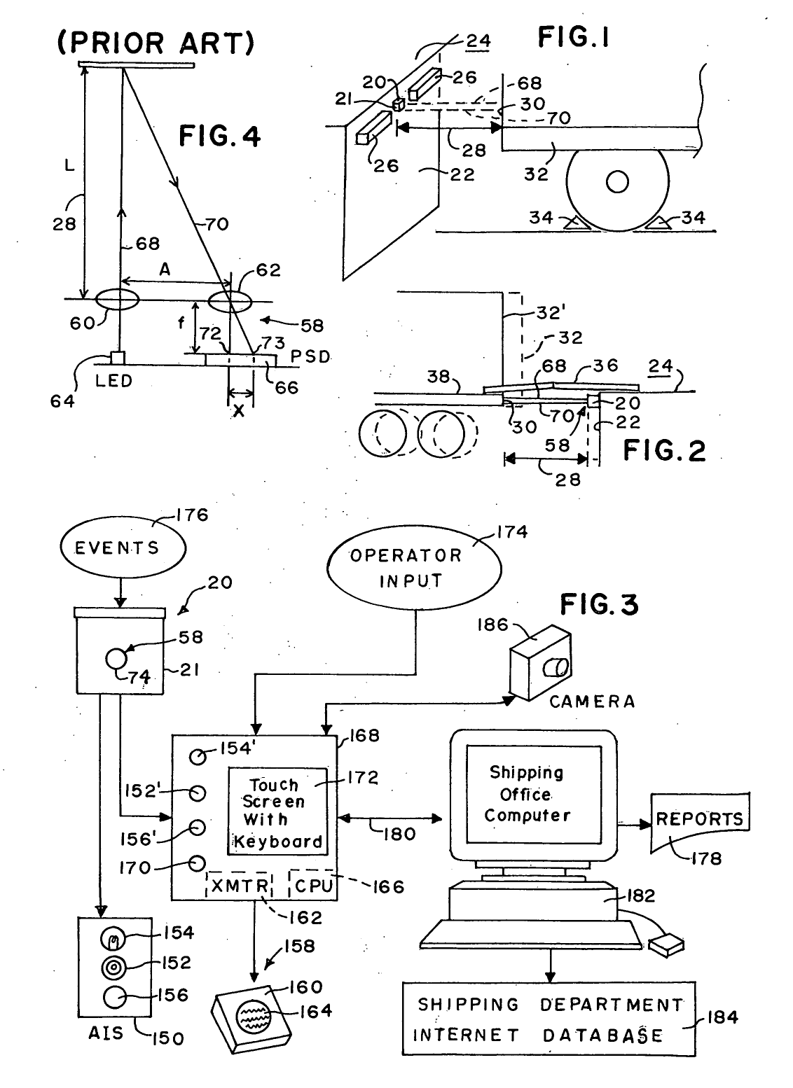

Referring to FIGS. 1-3, the loading dock monitoring device 20 of the present invention is preferably housed in a sealed metal enclosure 21 that provides substantial protection against wind, rain, snow, and ice, and device 20 is preferably mounted to an outward-facing surface 22 of a well-known loading dock 24 between well-known loading dock bumpers 26 and measures a gap distance 28 between the monitoring device 20 (and thus from dock 24) and a portion, preferably a rear portion 30, of a parked load transport vehicle 32. While parked, load transport vehicle 32 typically has its wheels secured by well-known so-called “chock blocks” 34 and/or by setting the brakes on the load transport vehicle in a manner well-known to those skilled in the art. While being unloaded or loaded, a well-known ramp or dock plate or dock leveler (generically indicated as 36) is used to span the gap 28 between the dock 24 and the load transport vehicle's bed floor 38. It shall be understood that the present invention works equally as well with simple well-known one-peice dock plate bridges and ramps that span the gap between a dock and the bed floor of a parked load transport vehicle as it does with more complex well-known electromechanical, hydraulic, or pneumatically-operated dock leveler systems that span the gap between a dock and the bed floor of a parked load transport vehicle. As hereinafter explained in detail, the non-contact dock monitoring device 20, without physically contacting the load transport vehicle, evaluates when the measured gap distance 28 increases outside a selected limit distance, as shown by the moved location 32′ in FIG. 2, and signals an alarm to indicate a hazardous condition for dock workers caused by the movement of the load vehicle away from the dock.

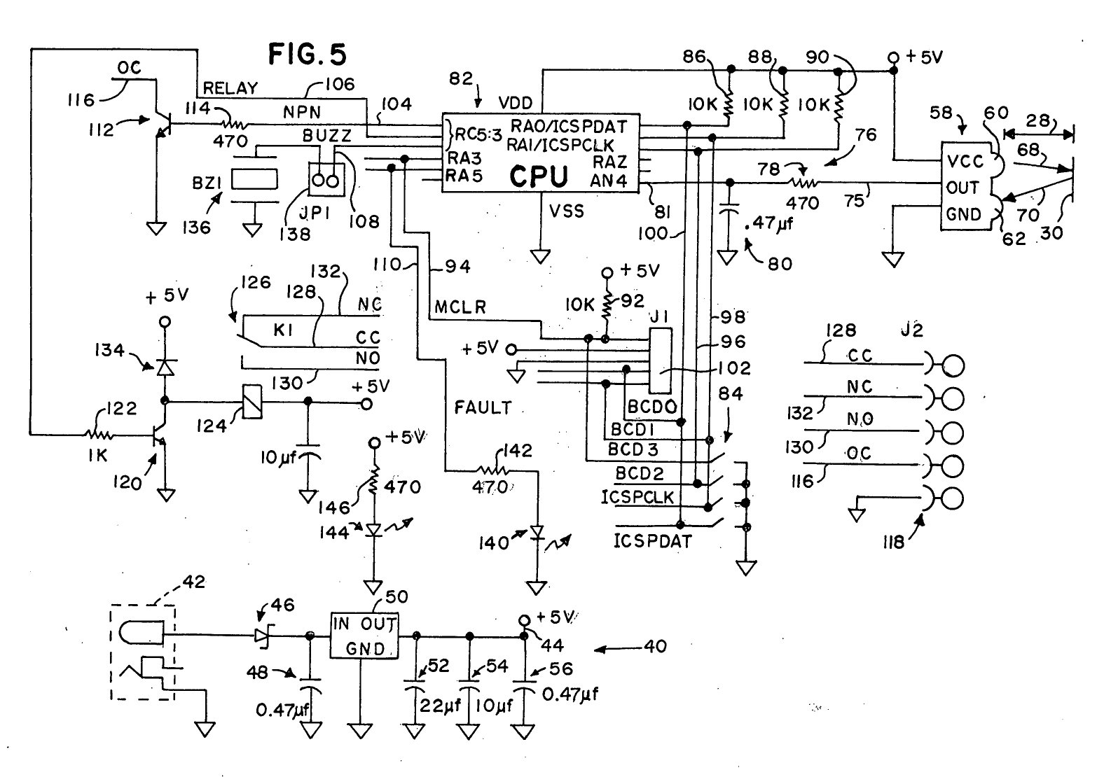

Referring to the schematic shown in FIG. 5, the various parts of the basic portion of a preferred embodiment of dock monitoring device 20 will now be explained.

Reference numeral 40 generally denotes a well-known power supply that converts the input voltage (typically, 6 to 16 volts D.C.) applied through jack 42 into a filtered 5 volts D.C. at node 44 for supplying the circuitry of dock monitoring device 20. A diode 46, such as a well-known BAT54 Schottky barrier diode manufactured by Fairchild Semiconductor, Inc., protects the power supply 40 from reversed polarity voltage being applied. Input filter capacitor 48 filters the input voltage from jack 42 to voltage regulator 50, such as a well-known LM2940-5 three-terminal five-volt voltage regulator manufactured by National Semiconductor, Inc., and output filter capacitors 52, 54, and 56 filter the output voltage at node 44.

Distance measuring means 58, for measuring the gap distance between the loading dock and a portion of the parked load transport vehicle, is preferably an optical distance measuring sensor such as the well-known Sharp GP2Y0A02YK distance measuring sensor. Even though the operation of this sensor is disclosed in a prior art publication entitled GP2Y0A02YK Long Distance Measuring Sensor published by Sharp Corporation (date unknown) and in an application note entitled General Application Note: Distance Measuring Sensors, also published by Sharp Corporation (Feb. 18, 2003), the operation of the distance measuring sensor will now be briefly explained.

Referring to FIGS. 4, 5, and 9, the Sharp GP2Y0A02YK distance measuring sensor measures the gap distance L (denoted by reference numeral 28) between the loading dock and the load transport vehicle using optical triangulation, and has a pair of lenses 60, 62 spaced apart a distance A, with lens 60 being in front of an outward-facing infrared LED 64 and with lens 62 being in front of a well-known position sensing device (“PSD”) 66. LED 64, shining through lens 60, emits an infrared beam 68 that reflects off of the target (the portion 30 of load transport vehicle 32) and back to PSD 66 through lens 62 as reflected beam 70. The focal distance of lens 62 is shown as f, and the reflected beam 70 is seen, by geometry, to impinge between a fixed point 72 on PSD 66 when the target is at or near an infinite distance L away, and a varying point 73 as the target becomes nearer, with the distance between fixed point 72 and varying point 73 being denoted by X. By geometry, as given in the Sharp Corporation application note entitled General Application Note: Distance Measuring Sensors, the relation between these quantities is given as the scalar function:

$$X = \frac{A \times f}{L}$$

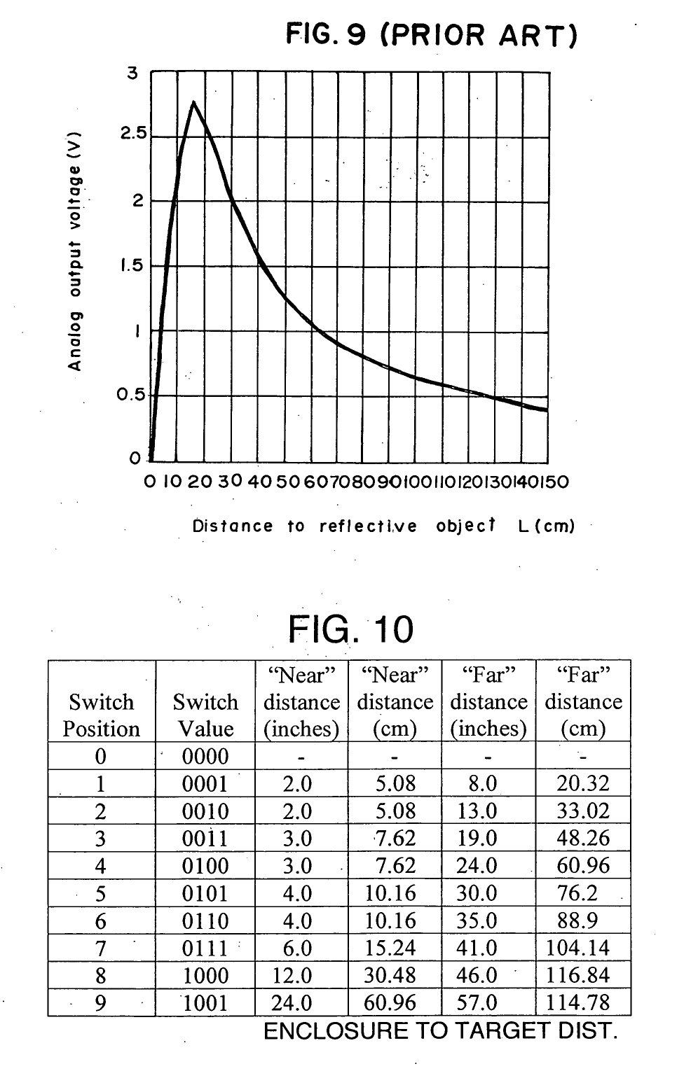

or, equivalently,

$$L = \frac{A \times f}{X}$$

where A and f are known physical dimensions determined by the construction of the Sharp GP2Y0A02YK distance measuring sensor such that, when the distance X is measured at the PSD, the target distance L then becomes known by optical triangulation. Preferably a well-known outwardly-extending tubular light shade 74 (encircling beams 68, 70 adjacent lenses 60, 62) is provided to shield the PSD 66 from ambient light. FIG. 9 shows the typical output voltage (on node 75 in FIG. 5) of the Sharp GP2Y0A02YK distance measuring sensor as a function of the distance L to the target (portion 30 of load transport vehicle 32), and this voltage at node 75 is passed through a low-pass filter 76, formed by resistor 78 and capacitor 80 (see FIG. 5) to remove noise, and is then input to Analog-to-Digital converter input AN4 (reference numeral 81) of a well-known programmable single-chip microcontroller (microcomputer or “CPU”) 82 such as the well-known PIC16F636 microcontroller made by Microchip Technology, Inc.

As can be seen by the graph of FIG. 9, the Sharp GP2Y0A02YK distance measuring sensor is not useful for accurately measuring extremely short distances, but it is rather accurate for measuring distances in the range of about 2 or 3 inches to 4 feet (about 6 cm to 122 cm). It should also be understood that the graph of FIG. 9 shows typical nominal output voltages, and it may be necessary to calibrate a particular device, as used within the circuit of FIG. 5, using a calibration procedure to record voltages measured by CPU 82 for various distances measured by a given device 58 and then calibrate the values accordingly for more accurate measurements.

As shown in FIG. 5, a switch 84, preferably a well-known ten-position BCD switch, is provided with pullup resistors 86, 88, 90, 92 for inputting data into CPU 82. The four data bits representing the setting, shown in the table of FIG. 10, of switch 84 are read by CPU 82 by multi-function inputs RA3, RA2, RA1/ICSPCLK, and RA0/ICSPDAT, which respectively pass the four binary digits of the switch setting value to the computer program stored in CPU 82 according to the following table:

TABLE 1

| Signal Name | CPU Input | Reference Numeral |
|---|---|---|
| BCD3/MCLR | RA3 | 94 |
| BCD2 | RA2 | 96 |
| BCD1/ICSPCLK | RA1/ICSPCLK | 98 |
| BCD0/ICSPDAT | RA0/ICSPDAT | 100 |

These four binary digits are read by the program as programmable port “A” of CPU 82 when reading the setting of switch 84 and are used to establish the selected “near” and “far” limit distances against which the measured distance 28 (as determined by the measured voltage 75) is compared. As explained further hereinafter, this comparison is performed by the computer program so as to provide discriminator means for evaluating whether the measured gap distance is within the selected limit distance.

When switch 84 is not being used to pass particular “near” and “far” limit distances to the computer program, it may instead be set to position “0” (allowing all signals of switch 84 to be pulled high through resistors 86, 88, 90, 92) and the multifunction inputs RA1/ICSPCLK and RA0/ICSPDAT may then be used to program the flash memory of the GP2Y0A02YK CPU with a desired computer program for proper operation of the present invention, using the signals brought to connector jack J1 (reference numeral 102) for mating with an appropriate plug and well-known external programming circuitry during the “in-circuit serial programming” of the flash memory of CPU 82 in a manner well-known by those skilled in the art.

Four outputs of CPU 82 are used to perform various control functions during operation of the present invention according to the following table:

TABLE 2

| Signal Name | CPU Output | Reference Numeral |
|---|---|---|
| NPN | RC5 | 104 |
| RELAY | RC4 | 106 |
| BUZZ | RC3 | 108 |
| FAULT | RA5 | 110 |

Signal NPN (104) drives the base of transistor 112, preferably a well-known BD705 NPN transistor, through a resistor 114 to provide an open-collector pull-down signal OC (reference numeral 116) to jack J2 (reference numeral 118) for controlling external devices. Signal RELAY drives the base of transistor 120, preferably a well-known 2N3904 NPN transistor, through a resistor 122 to actuate the coil 124 of relay K1 (reference numeral 126), such as a model G6RN-1-DC5 relay sold by Omron Electronics, LLC, so as to also provide signals CC (“center contact”, reference numeral 128), NO (“normally open”, reference numeral 130), and NC (“normally closed”, reference numeral 132) to jack J2 (reference numeral 118) for controlling and actuating external devices in a manner well-known to those skilled in the art. Diode 134, preferably a well-known BAS21 general-purpose high-voltage diode sold by Fairchild Semiconductor, Inc., protects transistor 120 from inductive spikes caused by the coil of relay 126.

Signal BUZZ (108) drives an alarm device, such as a well-known model CEP2272A 90 db piezoelectric buzzer BZ1 (reference numeral 136), to provide an alarm for signaling that the measured gap distance is greater than the selected limit distance, thereby indicating that an unsafe condition exists, in a manner hereinafter explained in greater detail. If desired, during installation of the present invention, a normally-present jumper across jumper terminals JP1 (reference numeral 138) may be removed to silence the annoying buzzer alarm by inhibiting the flow of signal BUZZ (108) to buzzer BZ1 (136).

Signal FAULT (110) drives a light-emitting diode (LED) 140 through resistor 142 to indicate that a fault condition has been detected by CPU 82. Light-emitting diode (LED) 144 is connected to the 5 volt power node 144 through resistor 146 to provide a simple indication that power is applied to the circuit of FIG. 5.

Referring now to FIGS. 1, 2, and 7A-7B, and with an understanding of and reference to the heretofore-explained circuitry shown in FIG. 5, the structure and operation of the present invention can now be explained.

When the CPU 82 is powered up, it goes through an initialization and self-check sequence, initializes its programmable I/O ports, initializes its analog-to-digital (“A/D”) converter, initializes various program parameters, sets a hysteresis variable “hyst” to 0 and sounds two short beeps to indicate successful initialization. The program then reads the position of switch 84 and establishes values for “near” and “far” distance variables according to the table shown in FIG. 10. It should be understood that the values given in the table of FIG. 10 are simply exemplary in nature, and can be changed if desired. It should also be understood that the distances shown in FIG. 9 include a 2.5 inch (6.35 cm.) distance that is subtracted in each of the “near” and “far” distances given in FIG. 10, because the distances given in FIG. 10 are measured from the front of the enclosure, which is spaced 2.5 inches from the front of distance measuring means 58, to account for the tubular light shade 74. If there is no object within the sensing range of the distance measuring device (i.e., measured gap distance is beyond the “far” distance), the program will illuminate the fault LED 140 but will not sound the alarm.

Alternatively, once the vehicle is parked, the distance from the dock can be measured by the distance measuring means 58 as a reference point, and a selected threshold can be added to the measured reference point distance to create a selected limit distance past which an alarm condition can be signaled. This alternative way of setting the selected limit distance allows for normal slight movement of a truck as loading/unloading occurs, but also signals when an unsafe condition is developing (by movement from the reference point/parked position) at an earlier time than when the vehicle moves beyond a fixed distance from the loading dock.

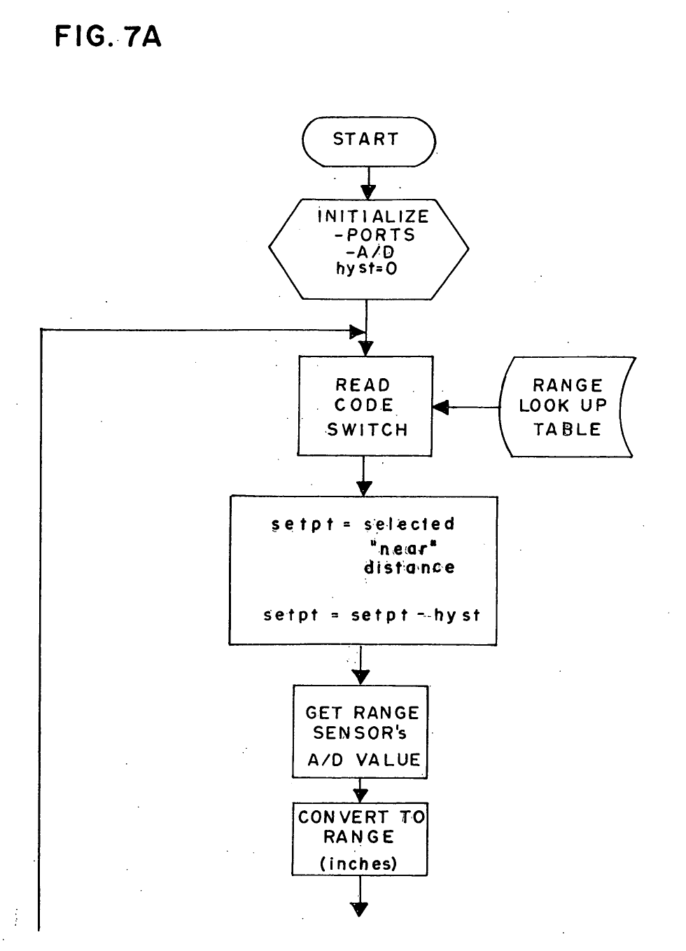

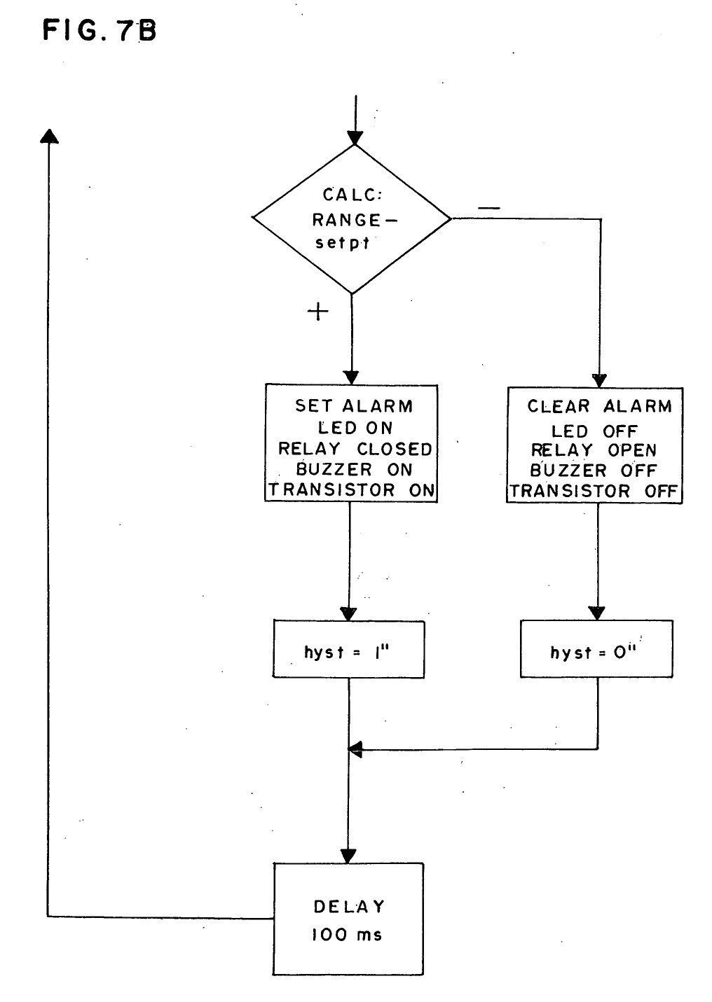

As a load transport vehicle approaches the dock as by backing up, eventually the measured gap distance becomes less than the “far” distance, and the program sounds the alarm 136, closes relay 126 by turning on transistor 120, turns on transistor 112 to assert signal 116 (“OC”), and changes the value of hysteresis variable “hyst” to one inch to prevent “relay chatter” as successive passes are made through the measurement loop shown in FIGS. 7A and 7B, delays for 100 milliseconds, and then re-enters the measurement loop for another measurement. When the measured gap distance becomes less than the “setpt” distance (“near” distance with hysterisis), the alarm 136 is silenced, relay 126 is opened by turning off transistor 120, transistor 112 is turned off to de-assert signal 116 (“OC”), and the value of hysteresis variable “hyst” is set to zero. The load transport vehicle is now within the “safe” loading distance and can be parked and the wheels chocked, but the dock monitoring device continues to monitor the gap distance between the dock and the load transport vehicle. It should be understood that, when the choice is made for the value of the “near” distance, a safety margin, typically four inches (the minimum overlap distance recommended by the American National Standards Institute (“ANSI”) for overlap of a dock ramp 36 onto the load vehicle's bed floor 38), should be subtracted from the desired maximum safe gap distance so as to provide sufficient safety margin of overlap of the dock ramp onto the load vehicle's bed floor.

Each time through the measurement loop, the program behaves as a discriminator means 148, for evaluating whether the measured gap distance is within a selected limit distance, as it evaluates the expression:

RANGE−setpt

where RANGE is the measured gap distance 28 and setpt is the selected limit distance, preferably including a hysteresis value to prevent oscillation of the discriminator means as the gap distance changes in the vicinity of the selected limit distance.

As the program of the dock monitoring device continues to monitor the gap distance 28 to the load transport vehicle, if the gap distance then increases beyond the predetermined “near” distance, the program, detecting that an unsafe condition now exists, sounds the alarm 136, closes relay 126 by turning on transistor 120, turns on transistor 112 to assert signal 116 (“OC”), and changes the value of hysteresis variable “hyst” back to one inch to prevent “relay chatter” as successive passes are made through the measurement loop shown in FIGS. 7A and 7B, delays for a short amount of time such as 100 milliseconds, and then re-enters the measurement loop for another measurement.

It will thus be understood in accordance with the above explanation that distance measuring means 58 outputs a signal, such as the voltage it presents on node 75, that is indicative of the measured gap distance from the dock to a portion of the parked load transport vehicle, for evaluation by the discriminator means 148 of the program running in CPU 82. It should be understood that discriminator means 148 is preferably implemented using the programmatic arithmetic operations heretofore described, but that it could equivalently be implemented by a voltage comparator that compares the voltage at node 75 with a pre-set voltage indicative of the voltage output from distance measuring means 58 for a selected limit distance.

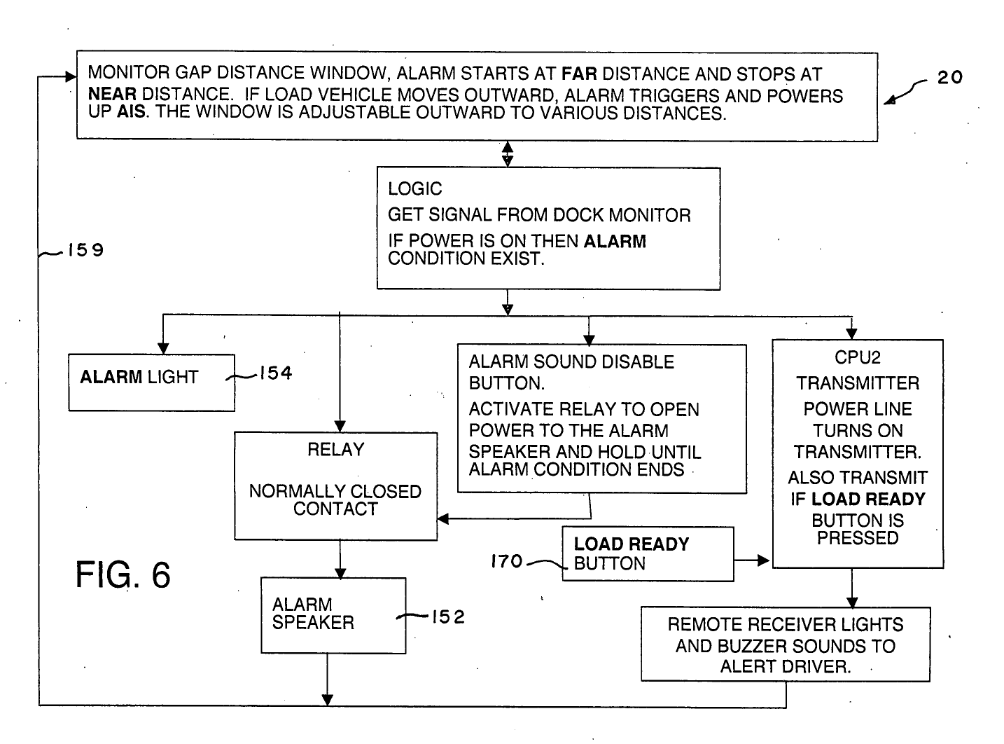

Referring now to FIGS. 3 and 6, additional structure and operation of the present invention can now be explained.

A well-known alarm indication station (“AIS”) 150, preferably a model AIS alarm indication station made and sold by Kele, Inc. and having an 80 db alarm horn 152, a light 154, and an alarm disable switch/button 156 for disabling the alarm/horn 152, is preferably provided and interfaced to the circuit of FIG. 5, heretofore described. The dock monitoring device 20 monitors the gap distance to the load vehicle as heretofore described, sounds the alarm if the gap distance is between the “far” and “near” distance, and turns the alarm off if the measured gap distance is less than the “near” distance. If the load vehicle then creeps outward from its safe parked distance, the alarm is triggered and the AIS 150 is powered on via the relay contact signals on jack 118 (J2). As heretofore described, the selected window limit distance can be adjustable by changing the position of switch 84.

External logic of the AIS 150, operating in accordance with the operations shown in FIG. 6, becomes powered through the relay contact 130 on jack 118 (J2) when an alarm condition exists, the alarm light 154 of AIS 150 is illuminated, and the alarm horn 152 is actuated through the normally-open contact of relay 126 (K1) as that normally-open contact closes. If the operator presses the alarm sound disable switch/button 156, power becomes removed from the alarm horn 152 and the alarm horn 152 then remains silent until the alarm condition ends; it should be noted that the alarm light 154 stays illuminated.

Notification means 158 may preferably be provided for notifying the load transport vehicle's driver that his/her attention is needed at the loading dock. One preferred embodiment of notification means 158 is a well-known vibrating annunciator paging device 160 manufactured by Long Range Systems, Inc., 9855 Chartwell Drive, Dallas, Tex. 75243, and that is disclosed in Henderson, U.S. Design Patent No. Des. 371,054 (issued Jun. 25, 1996) and Lovegreen et al., U.S. Pat. No. 5,814,968 (issued Sep. 29, 1998), both of which patents are fully included by reference herein. Vibrating annunciator paging device 160 has an included receiver that receives signals from a transmitter 162, and annunciator paging device 160 preferably has a well-known text messaging display 164 on which informative messages may be sent to the load transport vehicle's driver. When an alarm condition is signaled by dock monitoring device 20 and the AIS 150 becomes powered through the relay contact signals at jack 118 (J2), control circuitry, preferably a computer processing unit (“CPU”) 166 within a provided dock operator's interface panel 168, causes transmitter 162 to send a radio signal to paging device 160 so as to cause paging device 160 to vibrate and also to present an appropriate text message on display 164 so as to alert the load transport vehicle's driver to events and/or progress at the loading dock. Alternatively, notification means 158 may be a well-known pager device receiving a paging message, a telephone call or text message that dock monitoring device 20 causes to be placed to a telephone (such as a cellular telephone) carried by the load transport vehicle's driver, or an email message that dock monitoring device 20 causes to be sent to a desired email address. Notification means 158 is thus understood to be preferably selected from the group consisting of vibrating annunciator means, a pager, a telephone call, and an email message.

Alternatively or in addition to providing AIS 150, operator's panel 168 may be provided with similar functions, buttons, and alerts as AIS 150, namely, a light 154′, an alarm horn 152′, and an alarm silence button 156′, all having like function and operation as the similar-indicated and heretofore-described elements of AIS 150, and there may additionally be provided a “Load Ready” button 170 that the dock operator can press when the driver's load is ready for the driver to pull away from the dock, causing notification means 158 to alert the driver as heretofore described.

As shown in FIG. 6, when the alarm condition ceases to exist, the monitoring process restarts along logic path 159.

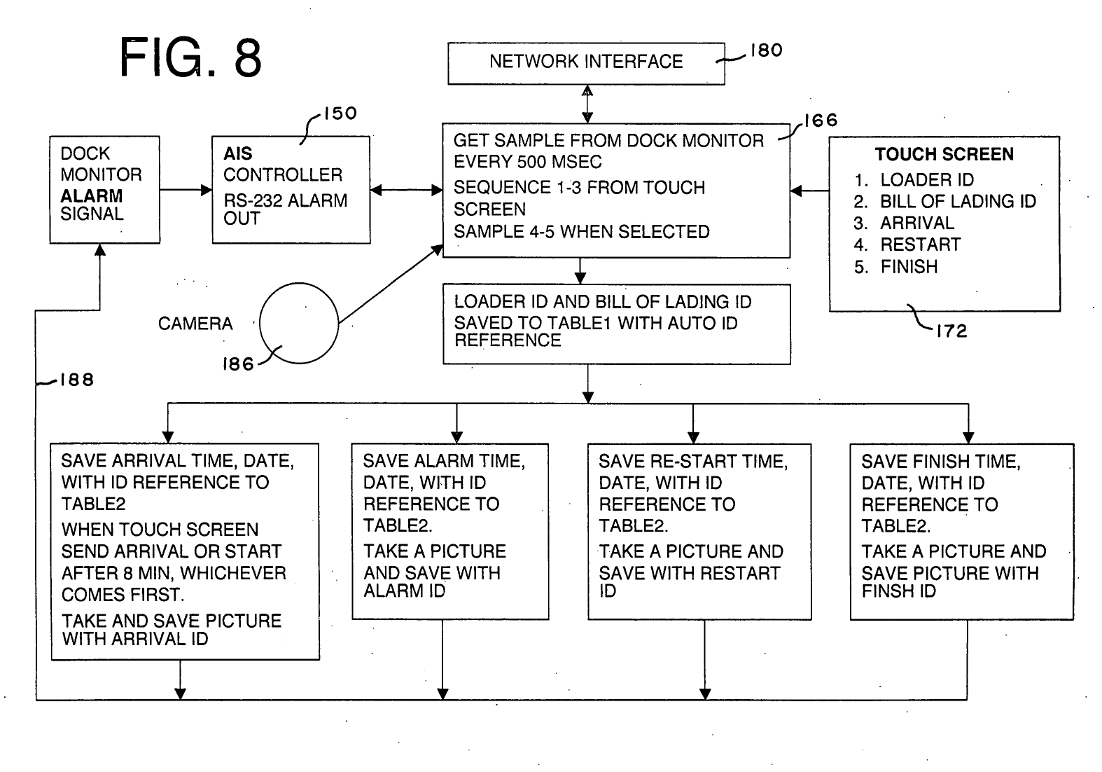

Refering now to FIGS. 3 and 8, additional structure and operation of the present invention can now be explained.

Operator's interface panel 168 is preferably provided with a so-called well-known “touch screen” and keyboard 172 interfaced to CPU 166 for receiving operator input 174 and for displaying information to the operator, and dock monitoring device 20 may also note a number of events and receive data (collectively, 176) relating to the load transport vehicle's cargo for logging thereof by well-known logging means such as computer storage media, printouts and reports 178, and transmission over a network 180 to another computer 182 or to a remote database such as, for example, a shipping department's database 184.

For example, the logged events can include the dock number to which the load transport vehicle is assigned and the arrival time. Additional logged events indicating a “failure” or alarm condition include having the monitored gap distance become greater than the selected limit distance and/or a premature trailer pull-away before authorization by the dock operator (i.e., prior to the operator's pressing of the “Load Ready” button 170), and such an alarm condition will be logged with the time of occurrence and will cause the alarm to sound and notification by notification means 158. If a normal departure occurs subsequent to the pressing of the “Load Ready” button 170, such a normal departure may also be logged with the time of occurrence.

The dock operator may input data related to the load transport vehicle's cargo via touch screen and keyboard 172. Such data may include the loader identification number (to be put on the bill of lading), the “Load Ready” event (caused by depressing of the “Load Ready” button 170, which will perform data-entry validation of entered data and highlight any fields on the touch screen for which incorrect data, or no data, has been provided). Additionally, the operator may cause a digital picture to be taken of the load via a camera 186, and the picture may be downloaded and printed on the Bill of Lading and/or transmitted to a remote computer and/or remote database, and the operator may also cause a completed order to be sent to a shipping office computer database and/or emailed to a predetermined email address.

Representative data that may be reviewed and/or verified by the dock operator relating to the load transport vehicle's cargo may include: a Bill of Lading, a company name, a truck number, and order information.

Representative data that may be entered by the dock operator relating to the load transport vehicle's cargo may include: a dock operator's and/or loader's identification number, a Bill of Lading number, the dock number, and the arrival and departure times.

Representative data that may be verified by the dock operator relating to the load transport vehicle's cargo may include: the order number, the products being loaded/unloaded and associated quantities, special instructions and notes, and load completion.

Safety data relating to the load transport vehicle's cargo that may be logged may include: the dock number, the operator identification number, the arrival time, the time of a failure event noted when the monitored gap distance becomes greater than the selected limit distance, a premature pull-away by the load transport vehicle (prior to the dock operator's pressing of the “Load Ready” button), and the departure time.

To accomplish all of this, and referring especially to FIG. 8, the computer 166 for example, may sequence the operator through items 1-3 (Loader Identification Number, Bill of Lading Identification Number, and Arrival Time) shown on touch screen 172, and then sample touch screen items 4 and 5 (restart, finish) and perform appropriate actions when those items are chosen.

The Loader Identification Number and Bill of Lading Identification Number are saved to a first database table with an automatically-generated identification reference number.

The arrival time and date are saved to a second database table with the automatically-generated identification reference number. When the operator uses the touch screen to signal the arrival of a load, or an appropriate time such as eight minutes elapsed after the arrival time is caused to be saved to the second database table, whichever comes first, the camera 186 is caused to take a picture of the load and to save that picture for future use.

Upon occurrence of an alarm event, the time of occurrence and date is logged to the second database table together with an alarm identification reference number and a picture concurrently taken by camera 186.

If the operator signals a “restart” action, the restart time and date is logged to the second database table together with a restart identification reference number and a picture concurrently taken by camera 186.

If the operator signals a “finish” action, the finish time and date is logged to the second database table together with a finish identification reference number and a picture concurrently taken by camera 186.

As shown by logic path 188, when the action at the bottom of the diagram is completed, the monitoring of the alarm status and inputs continues.

It will now be understood that the dock monitoring device 20 of the present invention is a preferred embodiment of practicing a method of monitoring a gap distance between a loading dock and a portion of a parked load transport vehicle. This method preferably comprises the steps of measuring the gap distance using optical triangulation by an infrared beam, evaluating whether the measured gap distance is within a selected limit distance, signaling an alarm if the measured gap distance becomes greater than the selected limit distance, and then notifying the load transport vehicle's driver and/or dock personnel that the alarm condition has occurred.

Although the present invention has been described and illustrated with respect to a preferred embodiment and a preferred use therefor, it is not to be so limited since modifications and changes can be made therein which are within the full intended scope of the invention.

We claim:

1: A loading dock monitoring device, said device comprising:
(a) non-contact distance measuring means for measuring a gap distance between a loading dock and a portion of a parked load transport vehicle;
(b) discriminator means for evaluating whether said measured gap distance is within a selected limit distance; and
(c) an alarm, operably connected to said discriminator means, for signaling that said measured gap distance is greater than said selected limit distance.

2: The loading dock monitoring device as recited in claim 1, in which said distance measuring means optically measures said gap distance by optical triangulation.

3: The loading dock monitoring device as recited in claim 1, in which said distance measuring means optically measures said gap distance.

4: The loading dock monitoring device as recited in claim 3, in which said distance measuring means outputs a signal, indicative of said measured gap distance, for evaluation by said discriminator means.

5: The loading dock monitoring device as recited in claim 3, in which said loading dock monitoring device further comprises operator input means for inputting data relating to said load transport vehicle's cargo.

6: The loading dock monitoring device as recited in claim 3, in which said loading dock monitoring device further comprises logging means for logging events and data relating to said load transport vehicle's cargo.

7: The loading dock monitoring device as recited in claim 3, in which said loading dock monitoring device further comprises a camera for taking a picture of the parked load transport vehicle.

8: The loading dock monitoring device as recited in claim 3, in which said loading dock monitoring device further comprises notification means for notifying the load transport vehicle's driver.

9: The loading dock monitoring device as recited in claim 8, in which said notification means is selected from the group consisting of vibrating annunciator means, a pager, a telephone call, and an email message.

10: The loading dock monitoring device as recited in claim 3, in which said in which said loading dock monitoring device further comprises vibrating annunciator means for notifying the load transport vehicle's driver.

11: A loading dock monitoring device, said device comprising:
(a) non-contact distance measuring means for measuring a gap distance between a loading dock and a portion of a parked load transport vehicle using optical triangulation, said distance measuring means providing an output signal indicative of said measured gap distance;
(b) discriminator means for evaluating said output signal and determining whether said measured gap distance is within a selected limit distance;
(c) an alarm, operably connected to said discriminator means, for signaling that said measured gap distance is greater than said selected limit distance;
(d) operator input means for inputting data relating to said load transport vehicle's cargo, said inputted data including a load ready indication; and
(e) logging means for logging events and data relating to said load transport vehicle's cargo.

12: The loading dock monitoring means as recited in claim 11, further comprising means for reviewing at least some of said events and data.

13: The loading dock monitoring device as recited in claim 12, further comprising database interface means for transmitting at least some of said significant events and data to a computer database.

14: The loading dock monitoring device as recited in claim 12, in which said loading dock monitoring device further comprises a camera for taking a picture of the parked load transport vehicle.

15: The loading dock monitoring device as recited in claim 12, in which said loading dock monitoring device further comprises notification means for notifying the load transport vehicle's driver.

16: The loading dock monitoring device as recited in claim 15, in which said notification means is selected from the group consisting of vibrating annunciator means, a pager, a telephone call, and an email message.

17: A method of monitoring a gap distance between a loading dock and a portion of a parked load transport vehicle, said method comprising the steps of:
(a) measuring said gap distance using optical triangulation by an infrared beam;
(b) evaluating whether said measured gap distance is within a selected limit distance;
(c) signaling an alarm if said measured gap distance becomes greater than said selected limit distance; and
(d) notifying the load transport vehicle's driver that said alarm condition has occurred.
